(19) United States
(12) Patent Application Publication
(10) Pub. No.: US 2025/0145006 A1
(43) Pub. Date: May 8, 2025

(54) BATTERY ELECTRIC MACHINE BRAKING PRODUCTIVITY CONTROL

(71) Applicant: Caterpillar Inc., Peoria, IL (US)

(72) Inventors: Karl P. Schneider, Decatur, IL (US); Andrew J. Olson, Vail, AZ (US); Cameron T. Lane, Oro Valley, AZ (US)

(73) Assignee: Caterpillar Inc., Peoria, IL (US)

(21) Appl. No.: 18/500,319

(22) Filed: Nov. 2, 2023

(51) Int. Cl. B60L 7/26; B60L 58/15; B60L 58/26

(52) U.S. Cl. CPC B60L 7/26; B60L 58/15; B60L 58/26; B60L 2200/40; B60L 2240/545

(57) ABSTRACT

An apparatus for controlling braking systems comprises an energy storage device to absorb energy emitted by a primary braking system. The apparatus can include a controller coupled to the energy storage device to detect conditions of the energy storage device. The controller can predict a point at which the energy storage device will exhibit reduced capability to absorb energy. The controller can provide a control signal to control a secondary braking system to provide braking capability in advance of the predicted point.

### TECHNICAL FIELD

This disclosure relates generally to braking in electric machines. More particularly, the disclosure relates to controlling braking in systems that use regeneration to recover energy.

### BACKGROUND

Battery electric machines (BEM) are a type of electric machine that rely solely on electric power stored in a battery module to propel and operate the machine. Some BEMs use regenerative braking systems to recover the kinetic and potential energy of a machine, which is normally dissipated as heat by conventional braking systems. Other hybrid powered machines, as well as fuel cell-powered machines, can include similar batteries with regeneration braking and additional braking systems. The recovery of the kinetic and potential energy occurs during braking via an electric motor that operates as a generator to restore power to a battery or other energy storage device. Regenerative capacity is not constant across the energy storage device operating conditions and a sudden or unexpected reduction in regenerative capacity can lead to brake failure, among other concerns.

KR20210072172 describes a braking control method for an electric machine. The method includes generating an auxiliary braking force in an electric machine, the force being determined based on different variables including current machine speed, battery state information and upcoming path information used to simulate a future state.

### SUMMARY

This disclosure describes various techniques to control a secondary braking system based on conditions of an energy storage system designed to absorb energy from a primary braking system.

In some aspects, an apparatus comprises an energy storage device configured to absorb energy of a primary braking system. The apparatus further comprises a controller coupled to the energy storage device to receive data indicating conditions of the energy storage device. The controller is configured to predict a point at which the energy storage device will exhibit reduced capability to absorb energy and provide a control signal to control a secondary braking system to provide braking capability in advance of the predicted point.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an example of a work machine that can implement various techniques of this disclosure.

FIG. 2 is a flow diagram of a method for controlling braking productivity according to some embodiments.

FIG. 3 illustrates machine learning engine for training and execution in accordance with some embodiments.

FIG. 4 depicts a power system diagram that can implement various techniques of this disclosure.

FIG. 5 is a flow diagram of a second method for controlling braking productivity according to some embodiments.

FIG. 6 is a flow diagram of a method to control a drivetrain of a work machine according to some embodiments.

FIG. 7 illustrates regeneration capacity of an energy storage device with respect to state of charge and temperature of the energy storage device.

FIG. 8 illustrates regeneration capacity of an energy storage device with respect to state of charge and power of the energy storage device and of secondary systems.

FIG. 9 is a computer system on which example embodiments can be implemented.

### DETAILED DESCRIPTION

Battery electric machines (BEM) use regeneration (absorbing energy back to the battery) as the primary braking means to improve efficiency by recovering kinetic and potential energy, reducing the charging energy needed for the BEM and thereby minimizing operating costs and maximizing productivity through the need to charge less frequently. Regeneration can be of particular use for applications involving large changes in potential energy through elevation change, such as locomotive, mining and construction applications, where braking energy can be a majority of the total energy transferred. The described embodiments relate to a regeneration control device of an electrically powered machine.

BEMs typically include a battery device including one or more storage cells and a motor which rotates by electric power supply from the battery device, and drives driving wheels using the motor as a power source. In such an electrically powered machine, at the time of braking, braking of the driving wheels is performed by regenerative torque of the motor, the motor generates electric power using torque of the driving wheels, and the generated electric power is charged into the cells, to thereby perform electric power regeneration.

BEMs often include a primary braking system (regenerative) and at least one additional (secondary) braking system. Blended braking can be used, wherein the additional braking system (which can include, e.g., resistive brakes, service brakes, or friction brakes) are brought into service where needed, depending on different criteria. For example, when battery charge indicates that further regeneration will be difficult or impossible, the other types of braking may be used.

The secondary braking system typically has some continuous power capacity, although the capacity of the secondary braking system may be inferior compared to the regeneration capability. Therefore, if regeneration capability is derated there may not be sufficient secondary system capacity to supplement the regeneration capability up to full machine performance, wherein machine performance can be limited by downstream components such as traction motors or power electronics. The condition can be exacerbated if there is a sudden drop or roll off in capacity once storage devices are outside a regenerative full performance range, which can be based on parameters such as state of charge (SoC) and temperature. Furthermore, it can be difficult to predict if and when regeneration capacity will be derated (e.g., when the energy storage device will exhibit reduced regeneration capacity) because regeneration capacity is not constant across a battery range. For example, depending on the battery SoC and temperature, there may be steep declines in capacity once thresholds have been exceeded. When capacity is exceeded, machine productivity shall be reduced or additional systems may be employed, which can in turn have a cost associated (e.g., wear and tear on friction brakes or other components, etc.).

Systems, methods and apparatuses according to example embodiments address these concerns by providing a control strategy to improve or enhance productivity of the braking system by estimating a SoC increase (or other energy storage device conditions) due to braking, evaluating regeneration capacity reduction due to the increased SoC, arbitrating a secondary braking system usage, and controlling the secondary braking system usage based on future battery SoC power limits. In the context of embodiments, SoC refers to the current amount of stored electrical energy in a battery, expressed as a percentage of its maximum capacity. SoC represents the immediate level of charge available in the battery at a given time. SoC indicates how much energy is remaining in the battery, within the manufacturer's specified operating range, with 0% indicating a completely discharged battery and 100% indicating a fully charged battery. SoC changes dynamically as the battery is discharged or charged.

While battery systems are referred to herein, storage can include any type of device capable of storing or dissipating energy such as flywheels, capacitors, heat sinks etc. Furthermore, while a secondary braking system is described, there can be more than two braking systems available.

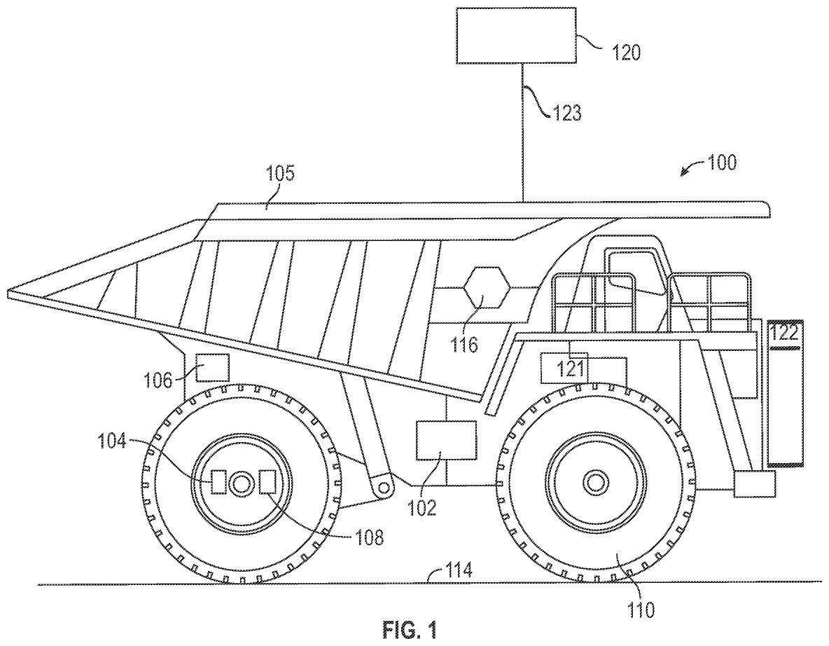

FIG. 1 is a perspective view of a work machine 100 (at least partially battery powered), according to one or more examples. FIG. 1 depicts a non-limiting view of a work machine 100 in the form of a haul truck (drop vehicle), such as for mining. The work machine 100 may be configured to be mobile to move to, from, through, and/or across a work site and may also be configured to perform work such as by use of a work implement of the work machine. The work machine 100 may include a battery 102, a wheel motor 104 and a drive system 106. The battery 102 may couple to electrical systems configured for controlling delivery of electrical power to the drive system 106 and/or one or more work implements. The power electronics may include motors, transformers (e.g., voltage level), inverters (e.g., DC-AC), rectifiers (e.g., DC-AC), voltage regulators, storage (e.g., battery capacitors), dissipators (e.g., resistive grid 116) and other electronic systems configured to deliver power to the drive system or one or more work implements. Still other electronic devices may be used to make up the power electronics.

The drive system 106 to leverage rotational energy or electrical energy from the power source to allow the work machine to move along a surface such as the ground 114 or conversely apply resistance to motion resulting in energy flow back into the machine. For example, the wheel motor may include an electric motor and drive shaft that delivers rotational energy to a traction system to turn wheels, rollers, cogs, or other types of traction systems configured for engaging the ground and moving the work machine along the ground. In some cases, the drive system 106 may be included in a transmission for adjusting the speed/power of rotational power from the electric motor or from a power take-off on a combustion engine, for example. The drive system 106 may also include systems and mechanisms for steering and braking of the work machine. The electric traction motor may provided in a variety of arrangements, including: one drive motor going to a differential driving one axle; individual drive motor in each wheel of an axle; or similar combinations on multiple axles. A cooling system 122 can provide cooling to the operator cab, or for drawing heat from the battery 102 or other components.

The dump body 105 may be operable by the hydraulic system to tip the dump body between a haul position and a more upright dump position. In other examples, the work machine 100 may include an excavator with other work implements in the form of a one or more booms and a bucket. The work machine 100 may also be a loader with a linkage and a bucket. Still other types of work machines 100 may be provided such as a bulldozer or skid steer with arms and a blade, forks, or bucket, or a compactor with one or more rollers and a vibration system.

The wheels 110 are examples of traction components. In other examples, the work machine 100 can include traction components such as one or more tracks, in addition to or instead of the wheels. As described earlier herein, a braking system 108 can be used to dissipate energy from machine motion, which depending on the type of braking device and machine system, can be used for regeneration to charge energy back to the energy storge device (including e.g., a traction motor to the battery), or can simply transfer energy to another medium (e.g., compression work, heat transfer, flow work), for example from oil cooled brakes to a cooler, resistor grid, or the atmosphere. However, regenerative capacity is not constant over the operating range of a battery. Accordingly, apparatuses and systems according to embodiments provide additional controls to predict future regeneration capacity and phase in use of a secondary braking system. In some examples, a brake offset such as brake calipers can be used, or the brake 108 can include a full circumference brake piston/pad, and these brakes may be dry (air cooled) or force cooled through another medium such as oil.

A controller 121 can be provided for electrically controlling various aspects of the work machine 100 including controlling regeneration and blended braking. The controller 121 can receive signals using communication circuitry 123 or communication circuitry connected to the battery 102 or other systems. For example, battery SoC, temperature, and other information can be received at the controller 121. The controller 121 can send and receive signals from various components of the work machine 100 during the operation of the work machine 100. The controller 121 can include onboard memory or memory in a remote location can be accessed. For example, the work machine 100 and controller 121 thereof can be wirelessly communicatively connected using communication circuitry 123 to remote system 120, wherein the remote system 120 can be used to monitor other machines of a fleet of work machines, or for remote processing.

In some examples, the work machine 100 can include electric vehicles, such as cars, trucks, motorcycles, buses, and the like. Although the techniques of this disclosure may be especially suited for use in battery-powered machines, the techniques can be used in hybrid-powered machines.

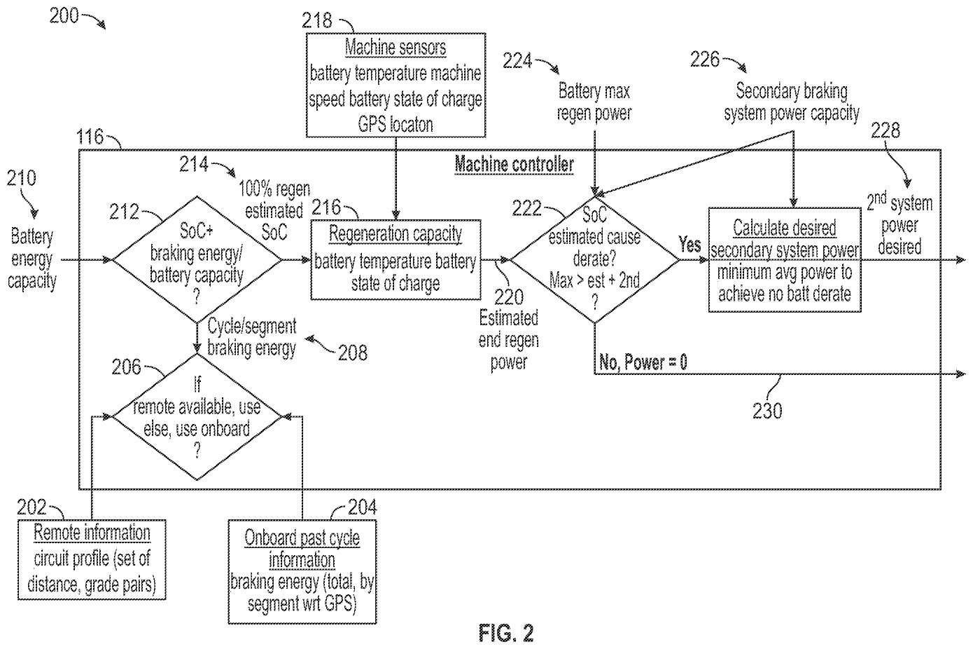

FIG. 2 is a flow diagram of a method 200 for controlling braking productivity according to some embodiments. The method 200 can be implemented by the controller 121.

Various inputs can be provided to the controller 121. The presence of a grade adds complexity to the braking process, as the gravitational force due to the slope can influence work machine 100 acceleration or deceleration or the power required to maintain work machine 100 speed. Therefore, as seen in remote information 202, the grade of a road (e.g., degree of slope or incline) is provided to the controller 121. For example, given a known route of the work machine 100 (or other machines of a fleet of work machines) the controller 121 can receive information (known as a circuit profile) that indicates the road grade at different distances along an expected route. The remote information 202 can be provided to the controller 121 from a remote system 120 (FIG. 1), wherein the remote system 120 is configured for centralized control and memory storage of information regarding the work machine 100 and/or related machines in a fleet of machines. Remote information 202 can be used in coordination with global positioning satellite (GPS) or other location information of the work machine 100 or nearby devices to predict upcoming braking needs as described below.

Additionally, or alternatively, onboard past cycle information 204 can be provided from work machine 100 memory, remote memory, or other storage. Onboard past cycle information 204 can indicate past braking energy usage of the work machine 100. Information can be provided as a total brake energy, brake energy per GPS segment, or other relationship/grouping. Onboard past cycle information 204 can be used in coordination with other sensors or devices particularly location-based systems. In some additional systems or embodiments, the work machine 100 can include or have access to an GPS route map provided by an offboard system (e.g., dispatch) and controller circuitry can determine the grade or incline of the current road surface to make a real-time determination regarding braking.

At decision 206, the controller 121 can decide whether to use remote information 202 or onboard information 204. When remote information 202 is available, the controller 121 may prefer remote information 202 over onboard past cycle information 204 because remote information 202 may be better able to predict conditions by knowledge of other vehicles in the fleet. Furthermore, remote system 120 may have additional processing power for learning and be better able to provide predictions.

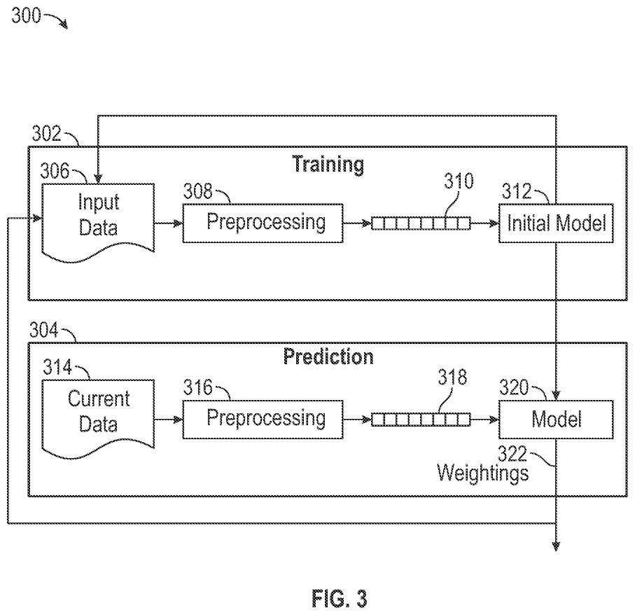

The controller 121 can provide a predicted cycle/segment braking energy 208. Further description of predicting and learning is provided with reference to FIG. 3 below.

The battery or other storage system provides a battery energy capacity 210 to the controller 121. At block 212, the controller 121 determines a sum of the SoC of the battery (or other storage system) and cycle/segment braking energy 208 to calculate the potential incremental SoC increase. This sum is added to the current SoC to estimate the absolute SoC estimated for 100% regeneration 214 at the end of the segment. Some estimates and functionality can also include an estimation of the battery temperature at the end of the segment based on the regeneration power over a segment duration (wherein a segment is a leg or portion of a work plan or trip), initial conditions, and colling system representation. Machine sensor inputs 218 are also provided for determining regeneration capacity 216. Machine sensor inputs 218 can include battery or storage device temperature, machine speed, SoC (of one or more available batteries/battery systems/storage devices), and GPS location.

The controller 121 uses regeneration capacity 216 to predict or determine the estimated end regeneration power 220 that would remain when braking needs have been met (e.g., work machine 100 is at final destination based on machine route, at bottom of a hill where braking needs can be reduced, etc.) without use of a secondary braking system. Next, at decision 222, the controller 121 can predict if the expected braking duration can be handled using only regeneration at maximum capacity. Battery maximum regeneration power 224 can vary as braking power is needed (for s the work machine 100 is going downhill) because the battery (or other energy storage device) fills and/or gets warmer with increased use. Accordingly, battery maximum regeneration power 224 can change continuously, or may be determined by accessing a lookup table or other database that associates current battery operating conditions relevant to capacity (e.g., battery temperature readings, ampere readings, voltage readings, state of health (SoH) etc.)). If battery maximum regeneration power 224exceeds the estimated end regeneration power 220 plus available secondary braking system power capacity 226, then the controller 121 calculates the amount of secondary system braking power 228 needed. As can be appreciated, this calculation is done proactively, in advance of secondary braking power being needed, and based on the predictions described above and below with respect to FIG. 3. For example, if braking performance would be reduced in absence of blending in secondary braking solutions, a blended braking schedule can be implemented wherein a secondary braking system (embodiments are not limited to two braking systems) is brought online to assist in braking.

The controller 121 can also adjust the amount of braking power applied by the secondary braking system. In example embodiments, the secondary system braking power 228 will be minimized to the amount needed to avoid machine derate, which is the combination of battery (potentially derated) and secondary system. A threshold factor can be applied (e.g., +/−5% or +/−10%) in case of unpredicted or unforeseen circumstances that would increase likelihood of derate. These circumstances may be related to environment, changes that increase amount of time enroute, the need to remove some or all storage cell/s from a battery system or take one or more storage cell/s offline, any other real-time situation or ad hoc requirements, etc. If no secondary braking power is needed, the controller 121 provides control signals 230 to indicate that secondary braking power should be zero or about zero.

FIG. 3 illustrates a machine learning engine 300 for training and execution in accordance with some embodiments. The machine learning engine 300 may be deployed to execute at the controller 121.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning).

The input data 306 may include battery energy capacity information for one or more energy storage device/s, which can include batteries although embodiments are not limited thereto. Inputs can include circuit profiles (e.g., distance and grade information) route and workplan information, location-based information, historical braking energy information, battery temperature and SoC information, and other sensor information. In the prediction engine 304, current data 314 may be input to preprocessing component 316. In some examples, preprocessing component 316 and preprocessing component 308 are the same. The prediction/reaction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction/reaction engine 304 may be designed to operate in an online manner (e.g., in real-time). In some examples, the model 320 may be periodically updated via additional training (e.g., via updated input data 306 or based on data output in the weightings 322) or based on identified future data, such as by using reinforcement learning to personalize a general model (e.g., the initial model 312) to a particular user. In some examples, the training engine 302 may use a trend analysis over time, for example with a user selected or a model identified range.

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms, including commercial algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 320 may be able to predict a time point at which secondary braking systems should be brought online, how much power such secondary systems should operate at, and blending considerations for blending primary and secondary power systems. For example, if four units (regardless of dimension) of braking are needed, three may be provided by the primary braking system and one by the secondary braking system. These predictions may be made based on historical cycle information of the work machine 100 or of a fleet of similar work machines or input historical data of other work machines or of ideal machines.

Using the above methodologies, blended braking can be applied proactively to minimize or eliminate the chance of battery derate, to maximize or improve amount of regeneration that occurs to recover braking energy, and to maintain safe and consistent braking operations through the life cycle of a work machine 100 and associated electrical systems.

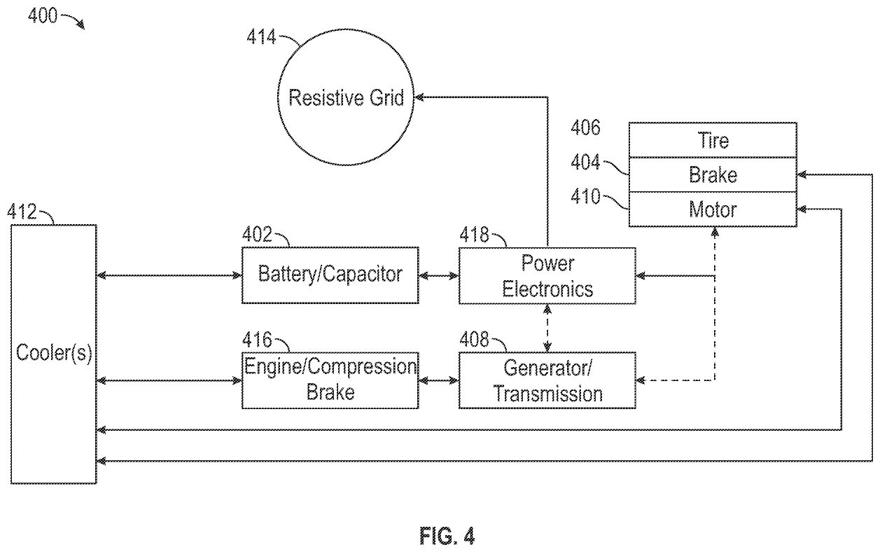

FIG. 4 depicts a power system 400 diagram that can implement various techniques of this disclosure. The power system 400 is configured to supply power to one or more components of a work machine, such as at least one traction component and/or at least one accessory component of the work machine 100 of FIG. 1.

The power system 400 comprises an energy storage device 402 (which can include a battery, flywheel, capacitor, etc.) and at least one other energy storage or dissipation device, such as friction brake cooling 412, resistive grid 414, or engine compression brake 416. The power system also comprises at least one braking torque mechanism, such as a friction brake 404 or traction motor 410, which apply braking torque to the tire/s 406. The power system 400 can be an electric drivetrain, including a generator 406 and electric motors 410, and power electronics, can be a mechanical drivetrain including transmission 408, or a combination of both in hybrid form. Other power electronics 418 can be included. Further, the work machine comprises cooling system/s 412, which are used to dissipate braking power or heat from related work from the various systems shown in FIG. 4.

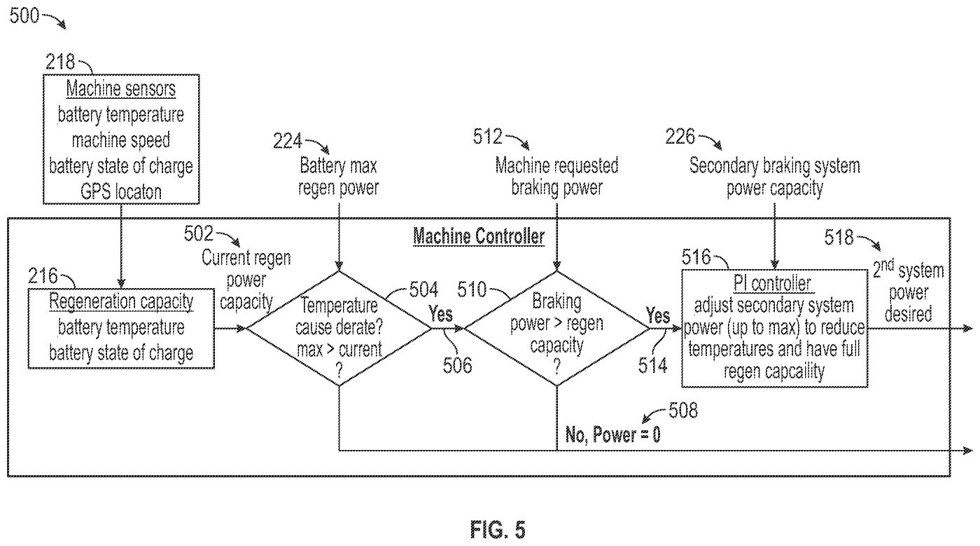

FIG. 5 is a flow diagram of a second method 500 for controlling braking productivity according to some embodiments. The method 500 can be implemented by the controller 121 or processing circuitry associated with the battery system 400 (FIG. 4).

The method 500 can be similar in some respects to the method 200, but in contrast to method 200, method 500 acts more in response to real-time changes of the work machine 100 to evaluate and respond to current state conditions.

The controller 121 (FIG. 1) can provide a predicted cycle/segment braking energy 208. Further description of predicting and learning is provided with reference to FIG. 3 below.

The controller 121 calculates a regeneration capacity 216 of the energy storage system based on machine sensor inputs 218. Machine sensor inputs 218 can include battery or storage device temperature, machine speed, SoC (of one or more available batteries/battery systems/storage devices), and GPS location. The controller 121 uses regeneration capacity 216 to determine the current regeneration power capacity 502 remaining in the energy storage devices (e.g., battery system). Next, at decision 504, the controller 121 can determine if conditions of battery or other storage system (e.g., temperature, current (ampere) limits, voltage level, etc.) would cause battery derate. For example, if the battery maximum regeneration power 224 exceeds the current regeneration power capacity 502, then battery derate may be eminent at branch 506. As an additional example, current limits can be reduced as SoC increases. Otherwise, the controller 121 provides control signals 508 to indicate that secondary braking power should be zero or about zero.

On the other hand, if battery derate is predicted or imminent, the controller 121 can proactively determine (at decision 510) whether work machine 100 requested braking power 512 is greater than the regeneration capacity of the battery/batteries or other energy storage devices. If the decision 510 evaluates to true at branch 514, this can indicate that a secondary system should be brought online in a blended braking strategy to prevent braking failures or other unsafe conditions. Otherwise, the controller 121 provides control signals 508 to indicate that secondary braking power should be zero or about zero.

As can be appreciated, this calculation is done proactively, in advance of secondary braking power being needed, and based on the predictions described above with respect to FIG. 3. For example, if braking performance would be reduced in absence of blending in secondary braking solutions, a blended braking schedule can be implemented wherein a secondary braking system (embodiments are not limited to two braking systems) is brought online to assist in braking.

Based on secondary braking system power capacity 226, the controller can implement an algorithm 516 (e.g., a proportional integral (PI) control algorithm, although embodiments are not limited thereto) to determine the amount of braking power applied by the secondary braking system. In example embodiments, the secondary system braking power 518 will be minimized to the amount needed to avoid battery derate. In some examples, the secondary system power 518 will be calculated to reduce temperatures of the energy system (e.g., batteries or other components shown in FIG. 2) to bring the energy system into a state that maximizes regeneration capacity of the energy system. A threshold factor can be applied (e.g., +/−5% or +/−10%) in case of unpredicted or unforeseen circumstances that would increase likelihood of derate. These circumstances may be related to environment, changes that increase amount of time enroute, the need to remove some or all storage cell/s from a battery system or take one or more storage cell/s offline, any other real-time situation or ad hoc requirements, etc.

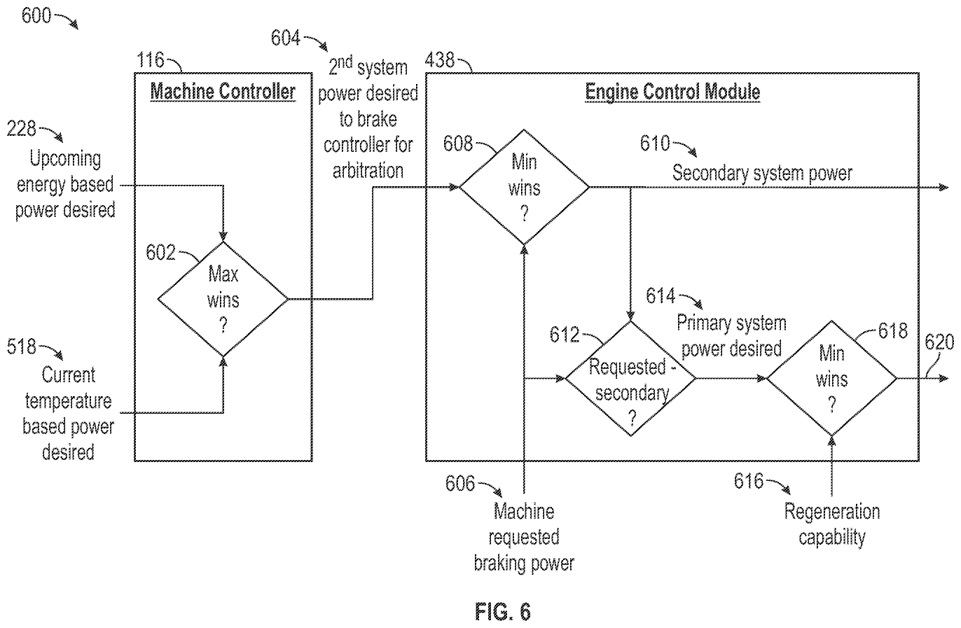

FIG. 6 is a flow diagram of a method 600 to control a drivetrain of a work machine according to some embodiments. The method 600 can be performed by the machine controller 121 in coordination and cooperation with other controllers of the work machine 100 such as the electronic control module 438 (or other controllers not shown, such as transmission controllers, etc.).

The inputs to method 600 include the amount of secondary system braking power 228 that was predicted or calculated to be needed by method 200. An additional input comprises the secondary system braking power 518 calculated or predicted according to method 500. As discussed earlier herein, secondary system braking power 228 can be based on predicted energy needs over a route or work plan, for example as based on machine learning with inputs of fleet historical data, etc., as described with reference to FIG. 2. In other examples, secondary system braking power 228 can be determined using a lookup table, relational database, or data structure that relates various energy storage device states and work machine 100 states to a desired or preferred secondary system braking power 228. The braking power 518 can be based on real-time measurements of temperature, etc. as described with reference to FIG. 5.

At decision 602, the controller 121 provides the maximum of secondary predictive braking power 228 and secondary real-time system braking power 518 as a secondary system power input 604 to the ECM 438. The machine requested braking power 606 is provided as an input to the ECM. At decision 608, the ECM 438 selects the minimum of a secondary system power input 604 and machine requested braking power 606 to set a value 610 for control the secondary system power. The decision at 608 and resulting value 610 signifies that the ECM 438 controls secondary system power to ensure that no more power is requested of the secondary system than can be provided by the secondary system. If braking demand is greater than the no-derate regeneration and secondary system capacity, then the system according to embodiments can provide up to 100% of the regeneration power (of what is available at derate) plus 100% available secondary power.

At calculation 612, the value 610 is subtracted from the machine requested braking power 606 to determine the primary system power 614 needed from the primary power system. The regeneration capability 616 of the primary braking system is provided as an input to the ECM 438. At decision 618, the smaller of the value 614 and value 616 is provided as the primary system power 620. In summary, the method 600 illustrated in FIG. 6 will determine the maximum between the secondary predictive braking power 228 and secondary real-time braking power 518 and apply that maximum up to the demanded braking power. The difference (e.g., demanded braking power minus secondary) will be required from the primary system (as limited by regeneration capability).

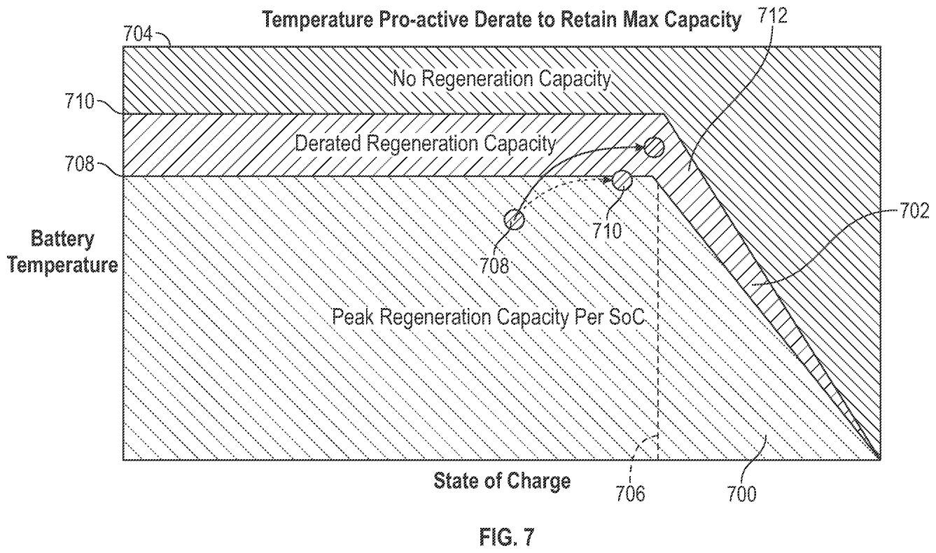

FIG. 7 illustrates regeneration capacity of an energy storage device with respect to state of charge and temperature of the energy storage device. In region 700, the energy storage device may have highest or peak regeneration capacity. In region 702, the energy storage device may have derated (or reduced) regeneration capacity. In region 704, the energy storage device may have zero or near zero regeneration capacity. It can be observed from FIG. 7 that the relationship between energy storage device regeneration capacity and SoC is not linear, e.g., there is a steep fall off when state of charge reaches a point 706, wherein further increases in temperature cause derate more readily. For example, when state of charge is at point 706, increasing the temperature above point 708 will likely start causing reductions in regeneration capacity. At temperature 710, the battery may begin to derate.

Methods according to embodiments proactively prevent or reduce instances of a corresponding energy storage device entering a state illustrated in region 702. For example, when an energy storage device is at state 708, as state of charge and temperature increase, the methods according to embodiments may proactively enable secondary braking systems, in a blended braking scenario, to end at point 710 staying within peak regeneration capacity, avoiding a temperature increase that would put the energy storage device at state 712 where all energy was consumed through regeneration, putting the system into derate due to temperature and ending SoC.

FIG. 7 is an example of derate and regeneration capacities as a function of temperature and state of charge and can depend on battery chemistry or other energy storage device chemistry. In general, as the state of charge goes up an energy storage device begins to run out of regeneration capacity.

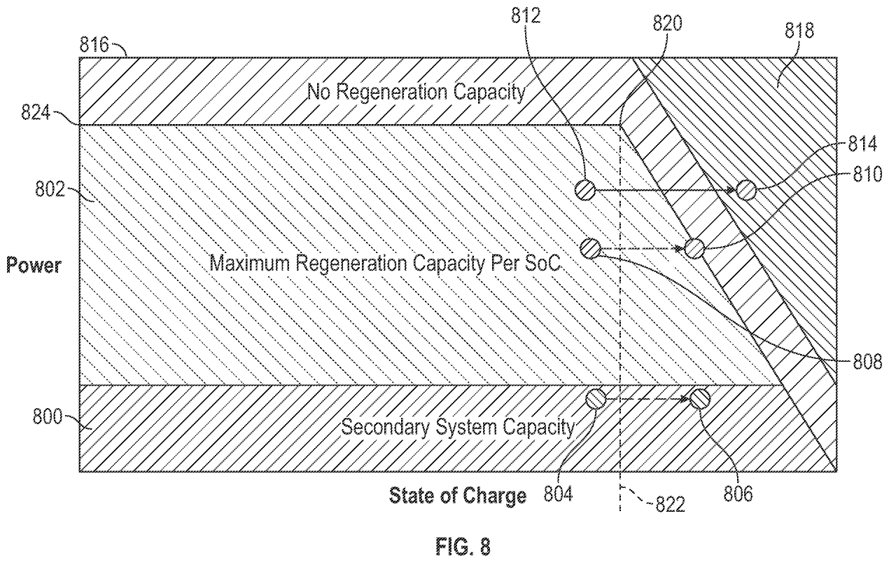

FIG. 8 illustrates regeneration capacity of an energy storage device with respect to state of charge and power of the energy storage device and of secondary systems. FIG. 8 illustrates that when secondary power 800 is used (in a proactive fashion before derating occurs), then the power 802 provided by the regeneration braking system can be reduced. For example, instead of a hypothetical regeneration-only profile going from point 812 to 814, a proactive blended approach can reduce regeneration from point 808 to point 810 by incorporating a secondary system from point 804 to point 806. Therefore, the proactive blended approach avoids a substantial reduction in regeneration capability at the end of the segment. As can be seen, if no secondary system is provided, the energy storage device may pass from region 802 into region 816 where no regeneration capacity is available. In some conditions (e.g., heavy braking use) the energy storage device may enter state 818 wherein work machine 100 slow down must occur for safety reasons. Therefore, by providing blended braking proactively according to methods described above, regeneration capacity can remain available throughout a work route, workday, or segment. Work machine 100 slow down can be reduced or eliminated, increasing productivity.

It can be observed from FIG. 8 that the relationship between energy storage device regeneration capacity and state of charge is not linear, e.g., there is a steep fall off when state of charge reaches a point 820, wherein further increases in power provided by the energy storage device cause derate more readily. For example, when state of charge is at point 822, increasing the power above point 824 will likely start causing reductions in regeneration capacity. Methods according to embodiments proactively prevent or reduce instances of a corresponding energy storage device entering a state illustrated in region 816 or 818.

FIG. 7 is an example of derate and regeneration capacities as a function of power and SoC, and can depend on battery chemistry, the type of energy storage device used (e.g., capacitor, flywheel, battery, etc. the construction of the energy storage device, and other factors. In general, as described with reference to FIG. 7, as the state of charge goes up an energy storage device begins to run out of regeneration capacity.

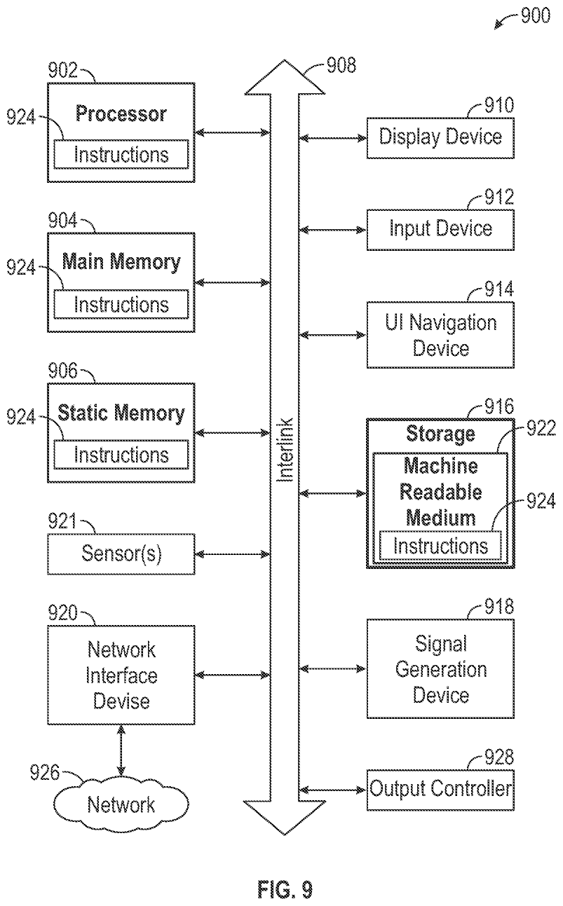

FIG. 9 illustrates generally an example of a block diagram of a machine upon which any one or more of the techniques (e.g., methodologies) discussed herein may perform in accordance with some embodiments. In examples, the machine 900 may include control circuitry or execute instructions associated with controlling braking systems to provide blended braking based on conditions of a work machine or energy storage system associated with a work machine. In alternative embodiments, the machine 900 may operate as a standalone device or may be connected (e.g., networked) to other machines. The machine 900 can provide communication inputs or outputs to operators either remote or local to the work machine 100.

Examples, as described herein, may include, or may operate on, logic or a number of components, modules, or mechanisms. Modules are tangible entities (e.g., hardware) capable of performing specified operations when operating. A module comprises hardware. In an example, the hardware may be specifically configured to carry out a specific operation (e.g., hardwired). In an example, the hardware may include configurable execution units (e.g., transistors, circuits, etc.) and a computer-readable medium containing instructions, where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, alphanumeric input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer, non-contacting sensors (laser, LIDAR, radar, sonar, camera-based) or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine-readable (or computer-readable) medium 922 that is non-transitory on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), a legacy telephone network, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and comprises digital or analog communications signals or other intangible medium to facilitate communication of such software.

### INDUSTRIAL APPLICABILITY

The present invention relates to techniques for using regeneration to improve machine efficiency by recovering energy (e.g., kinetic and potential energy) during braking of electric machines. As described, regeneration can reduce charging energy and charging duration needed to charge electric machines thereby reducing operating costs. Because regeneration capability is not constant or linear throughout battery operation and battery lifecycle, systems according to embodiments can be used to predict when secondary braking systems should be phased in, to avoid brake failure and other concerns. The present invention also prevents brake wear and brake life issues and can maintain braking productivity all the way down a hill or incline by managing energy through two or more systems. Maintaining braking productivity as described herein can reduce the need to slow or stop a work machine during descent of hills/inclines, thereby maintaining productivity and usefulness of the work machine. Battery life can also be improved by not running a battery into a derate condition.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. An apparatus comprising:
an energy storage device configured to absorb energy of a primary braking system; and
a controller coupled to the energy storage device to receive data indicating conditions of the energy storage device, the controller configured to:
predict a point at which the energy storage device will exhibit reduced capability to absorb energy; and
provide a control signal to control a secondary braking system to provide braking capability in advance of the predicted point.

2. The apparatus of claim 1, wherein the controller is configured to predict the point based on conditions of the energy storage device.

3. The apparatus of claim 1, wherein the conditions include a charge state or a temperature.

4. The apparatus of claim 1, wherein the controller is configured to control the secondary braking system and the primary braking system based on predicted braking usage of the primary braking system.

5. The apparatus of claim 4, wherein the controller is configured to implement a machine learning algorithm to predict braking usage.

6. The apparatus of claim 5, wherein the machine learning algorithm is based on inputs including historical braking trends, a working route of the work machine or a working route of a fleet of work machines.

7. The apparatus of claim 4, wherein the controller is further configured to determine a braking power needed from the secondary braking system to prevent derating of machine performance due to aggregate deration of braking systems.

8. The apparatus of claim 7, wherein the controller is further configured to implement a controlling algorithm to control the secondary braking system.

9. The apparatus of claim 1, comprising a plurality of energy storage devices.

10. The apparatus of claim 9, wherein the plurality of energy storage devices comprises at least one battery.

11. A work machine comprising:
a primary braking system and a secondary braking system;
an energy storage device configured to absorb energy of the primary braking system; and
a controller coupled to the energy storage device to receive data indicating conditions of the energy storage device, the controller configured to:
predict a point at which the energy storage device will exhibit reduced capability to absorb energy; and
provide a control signal to control a secondary braking system to provide braking capability in advance of the predicted point.

12. The work machine of claim 11, wherein the controller is coupled to the energy storage device through and interface, and wherein the controller is configured to predict the point based on conditions of the energy storage device, wherein the conditions include a charge state or a cooling mode.

13. The work machine of claim 11, further comprising communication circuitry configured to transmit and receive data related to a fleet of work machines, and wherein the controller is configured to control the secondary braking system and the primary braking system based on predicted braking usage of the primary braking system, wherein the controller is configured to implement a machine learning algorithm to predict braking usage based on inputs including historical braking trends, a working route of the work machine or a working route of the fleet of work machines.

14. The work machine of claim 11, wherein controlling the secondary braking system comprises determining a braking power needed from the secondary braking system to prevent derating of the work machine.

15. The work machine of claim 14, wherein controlling the secondary braking system comprises implementing a controlling algorithm.

16. The work machine of claim 11, comprising a plurality of energy storage devices, and wherein the plurality of energy storage devices comprises at least one battery.

17. A method comprising:
receiving data indicating conditions of an energy storage device;
predicting a point at which the energy storage device will exhibit reduced capability to absorb energy; and
providing a control signal to control a secondary braking system to provide braking capability in advance of the predicted point to avoid work machine performance reduction.

18. The method of claim 17, further comprising controlling the secondary braking system and a primary braking system based on predicted braking usage of the primary braking system.

19. The method of claim 18, further comprising implementing a machine learning algorithm to predict braking usage, and wherein the machine learning algorithm is based on inputs including historical braking trends, working route of the work machine or working route of a fleet of work machines.

20. The method of claim 17, wherein controlling the secondary braking system comprises determining a braking power needed from the secondary braking system to prevent derating of work machine performance.
